(19) United States
(12) Patent Application Publication
(10) Pub. No.: US 2025/0163603 A1
(43) Pub. Date: May 22, 2025

(54) ELECTROPOLISHING PROCESS FOR COMPLEX AM OBJECTS

(71) Applicant: Divergent Technologies, Inc., Los Angeles, CA (US)

(72) Inventors: Michael Thomas KENWORTHY, Rancho Palos Verdes, CA (US); Liaowang Liu, Long Beach, CA (US)

(21) Appl. No.: 18/948,335

(22) Filed: Nov. 14, 2024

Related U.S. Application Data
(60) Provisional application No. 63/601,658, filed on Nov. 21, 2023.

(51) Int. Cl. C25F 3/16; B22F 10/62; B33Y 40/20

(52) U.S. Cl. CPC C25F 3/16; B22F 10/62; B33Y 40/20

(57) ABSTRACT

A method for electropolishing complex additive manufacturing (AM) objects is disclosed. The method includes coating a surface of an additively manufactured (AM) structure with a first material. The method also includes creating a tool for polishing the AM structure in situ by coating the surface with a second material on top of the first material. The method further includes securing a gap between the tool and the surface of the AM structure that was coated with the first material, wherein the gap is based on a flow characteristic of the first material. The method finally includes removing the first material from the AM structure. In this way, the finishing of complex internal passageways of topologically optimized AM objects may be fully coated for all internal passages.

### CROSS-REFERENCE TO RELATED APPLICATIONS

This application claims priority to U.S. Provisional Application No. 63/601,658 titled “ELECTROPOLISHING PROCESS FOR COMPLEX AM OBJECTS,” filed on Nov. 21, 2023, which is assigned to the assignee hereof, and incorporated herein by reference in its entirety as if fully set forth herein.

### BACKGROUND

### Field

The present disclosure relates generally to additive manufacturing, and more specifically to a finishing process for additive manufactured (AM) objects.

### Background

Three-dimensional (3-D) printing, also referred to as additive manufacturing (AM), has recently presented new opportunities to more efficiently build complex transport structures, such as automobiles, aircraft, boats, motorcycles, busses, trains, and the like. AM techniques are capable of fabricating complex components from a wide variety of materials. Applying AM processes to industries that produce these products has proven to produce a structurally more efficient transport structure. For example, an automobile produced using 3-D printed components can be made stronger, lighter, and consequently, more fuel efficient. Moreover, AM enables manufacturers to 3-D print components that are much more complex and that are equipped with more advanced features and capabilities than components made via traditional machining and casting techniques. The 3-D objects may be formed using layers of material based on a digital model data of the object. A 3-D printer may form the structure defined by the digital model data by printing the structure one layer at a time.

3-D printing is non-design specific, which offers geometric and design flexibility that conventional manufacturing processes cannot. Furthermore, 3-D printing technologies can produce parts with very small feature sizes, and geometries that are either significantly difficult or impossible to produce using conventional manufacturing processes.

Despite these recent advances, a number of obstacles remain with respect to the practical implementation of AM techniques in transport structures and other mechanized assemblies. For instance, regardless of whether AM is used to produce various components of such devices, manufacturers typically rely on different mass finishing techniques to achieve high quality surface finishes. In general, most of the mass finishing techniques are used on objects with a simple shape or external surfaces of objects. However, there are not a lot of good finishing options for internal surfaces of objects—much less internal surfaces with multiple passages and complex geometries.

### SUMMARY

Several aspects of apparatus for systems and methods for finishing surfaces of AM objects will be described more fully hereinafter with reference to three-dimensional printing techniques.

A method in accordance with an aspect of the present disclosure comprises: coating a surface of an additively manufactured (AM) structure with a first material; creating a tool for polishing the AM structure in situ by coating the surface with a second material on top of the first material; securing a gap between the tool and the surface of the AM structure that was coated with the first material, wherein the gap is based on a flow characteristic of the first material; and removing the first material from the AM structure.

The method may optimally include the first material being a material configured to be dissolvable at a first temperature and the first material is removed from the AM structure by dissolving the first material at a first temperature.

The method may optionally include the first material corresponding to a wax or a low-melting polymer.

The method may optionally include the first material being alcohol soluble.

The method may optionally include the first material being water soluble.

The method may optionally include performing electropolishing on the AM structure in situ. The second material may be a conductive material configured to be dissolvable at a second temperature higher than the first temperature.

The method may optionally include the second material being configured as a cathode and the AM structure is configured as an anode.

The method may optionally include removing an electrode from the surface by cleaning the AM structure.

The method may optionally include applying acid to the AM structure. The second material may not be a conductive material.

The method may optionally include the gap being secured using a fixturing agent.

The method may optionally include the fixturing agent being a glue.

The method may optionally include performing a curing process to secure the gap, wherein the fixturing agent is an in-curing adhesive.

The method may optionally include the gap being secured using a feature incorporated in a wax-based tool configured to facilitate one or more robots maintaining a position between the AM structure and the tool.

The method may optionally include the first material being removed by melting or dissolving.

The method may optionally include the surface being internal and the first material being configured to fully coat all internal passages of a node.

The method may optionally include creating the tool further including filling a cavity of the AM structure with the second material.

The method may optionally include creating the tool further including partially filling a cavity of the AM structure with the second material.

The method may optionally include the surface being external.

The method may optionally include: re-coating a surface of the additively manufactured (AM) structure with the first material; re-creating an additional tool for polishing the AM structure in situ by re-coating the surface with the second material on top of the first material; securing at least a gap between the additional tool and a portion of the AM structure that was coated with the first material, wherein the gap is based on a flow characteristic of the first material; and re-removing the first material from the AM structure.

It will be understood that other aspects of joining structures (or structures) and subcomponents will become readily apparent to those skilled in the art from the following detailed description, wherein it is shown and described only several embodiments by way of illustration. As will be realized by those skilled in the art, the apparatus for adhesive fixturing is capable of other and different embodiments, and its several details are capable of modification in various other respects, all without departing from the invention. Accordingly, the drawings and detailed description are to be regarded as illustrative in nature and not as restrictive.

### BRIEF DESCRIPTION OF THE DRAWINGS

Various aspects of apparatus and methods for electropolishing complex AM objects will now be presented in the detailed description by way of example, and not by way of limitation, in the accompanying drawings, wherein:

FIGS. 1A-1D illustrate respective side views of a 3-D printer system in accordance with an aspect of the present disclosure.

FIG. 1E illustrates a functional block diagram of a 3-D printer system in accordance with an aspect of the present disclosure.

FIGS. 2A-2F illustrate a process of performing a finishing process for internal passageways of AM objects in accordance with an aspect of the present disclosure.

FIGS. 3A-3F illustrate an additional process of performing a finishing process for internal passageways of AM objects in accordance with an aspect of the present disclosure.

FIG. 4 is a flowchart illustrating an example method in accordance with the systems and methods described herein.

FIG. 5 is a flowchart illustrating an example method in accordance with the systems and methods described herein.

FIG. 6 is a flowchart illustrating an example method in accordance with the systems and methods described herein.

### DETAILED DESCRIPTION

The detailed description set forth below in connection with the drawings is intended to provide a description of exemplary embodiments of joining additively manufactured structures (or structures) and subcomponents, and it is not intended to represent the only embodiments in which the disclosure may be practiced. The term “exemplary” used throughout this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the disclosure to those skilled in the art. However, the disclosure may be practiced without these specific details. In some instances, well-known structures and components may be shown in block diagram form, or omitted entirely, in order to avoid obscuring the various concepts presented throughout this disclosure.

### Additive Manufacturing

Additive Manufacturing (AM) involves the use of a stored geometrical model for accumulating layered materials on a build plate to produce a three-dimensional (3-D) build piece having features defined by the model. AM techniques are capable of printing complex components using a wide variety of materials. A 3-D object may be fabricated based on a computer aided design (CAD) model. The CAD model can be used to generate a set of instructions or commands that are compatible with a particular 3-D printer. The AM process can create a solid three-dimensional object using the CAD model and print instructions. In the AM process, different materials or combinations of material, such as engineered plastics, thermoplastic elastomers, metals, ceramics, and/or alloys or combinations of the above, etc., may be used to create a uniquely shaped 3-dimensional object.

The use of producing AM components may provide significant flexibility and cost saving benefits. These, and other benefits may enable manufacturers of mechanical structures to produce components at a lower cost and/or in a more efficient manner. The techniques described in the present disclosure relate to a process for finishing AM components and/or commercial off the shelf (COTS) components. AM components are 3-D components that are printed by, for example, adding layer upon layer of one or more materials based on a preprogramed design. The components described herein may be components used to assemble a variety of devices, such as engine components, structural components, etc. Further, such AM or COTS components may be used in assemblies, such as vehicles, trucks, trains, motorcycles, boats, aircraft, and the like, or other mechanized assemblies, without departing from the scope of the present disclosure.

### Components and Terminology in AM

In an aspect of the present disclosure, a component is an example of an AM component. A component may be any 3-D printed component that includes features, such as an interface, for mating with another component. The component may have internal or external features configured to accept a particular type of component. Alternatively or additionally, the component may be shaped to accept a particular type of component. A component may utilize any internal design or shape and accept any variety of components without departing from the scope of the disclosure.

A component interface may be configured to connect to an interface of another component. For example, and not by way of limitation, an interface between components may be a tongue-and-groove structure. The interface may have high precision features or complex geometries that allow them to perform specific functions, including creating connections to spanning structures such as tubes, structural panels, extrusions, sheet metal, and/or other structural members.

For clarity, components may also include relatively simple connection features configured to connect with the more sophisticated network of connection features of the interface to form streamlined connections between structures. While these components may incorporate more basic features, they advantageously may be 3-D printed at a higher print rate. Alternatively, components may be built using a suitable non 3-D print manufacturing technology.

A number of different AM technologies may be well-suited for construction of components in a transport structure or other mechanized assembly. Such 3-D printing techniques may include, for example, directed energy deposition (DED), selective laser melting (SLM), selective laser sintering (SLS), direct metal laser sintering (DMLS), electron beam melting (EBM), powder bed fusion (PBF), and/or other AM processes involving melting or fusion of metallic powders.

As in many 3-D printing techniques, these processes (e.g., PBF systems) can create build pieces layer-by-layer. Each layer or “slice” is formed by depositing a layer of powder and exposing portions of the powder to an energy beam. The energy beam is applied to melt areas of the powder layer that coincide with the cross-section of the build piece in the layer. The melted powder cools and fuses to form a slice of the build piece. The process can be repeated to form the next slice of the build piece, and so on. Each layer is deposited on top of the previous layer. The resulting structure is a build piece assembled slice-by-slice from the ground up. SLS and various other PBF techniques may be well suited to construction of gear cases and other transport structure components. However, it will be appreciated that other AM techniques, such as fused deposition modeling (FDM) and the like, are also possible for use in such applications.

While the disclosure relates primarily to finishing of complex internal passageways of topologically optimized AM objects, the techniques described in his disclosure are not only applicable to internal passageways. For instance, the techniques may be applied to external surfaces of AM objects as well. In addition, while the disclosure also describes finishing surfaces of AM objects using electropolishing and chemical based polishing, any suitable technique for polishing a surface may be used without departing from the scope of the disclosure.

AM may include the manufacture of one or more nodes. A node is a structural member that may include one or more interfaces used to connect to other nodes or spanning components such as tubes, extrusions, panels, and the like. Using AM, a node may be constructed to include additional features and functions, including interface functions, depending on the objectives. As described herein, the term node and structure may be used interchangeably.

A focus of the AM industry has been around printing geometries with good surface quality. However, it may be difficult to alter printing parameters to achieve geometries with good surface quality without having to print supports. Printing supports is non-ideal because the supports are difficult to remove and leave residual material on the surface which may be problematic for certain applications.

There are several mass finishing techniques that may be applied to achieve a high quality finish on simple objects or external surfaces. For example, a first mass finishing technique is electrochemical machining, which is a method of removing metal by an electrical chemical process. Electrochemical machining may be used for mass production and for working extremely hard materials or materials that are difficult to machine using conventional methods. In the electrochemical process, a negatively-charged (e.g., cathode) cutting tool is advanced into a positively charged (e.g., anode) workpiece such that a charge exchange takes place between the cathode and the anode in an aqueous electrolyte solution which targets specific areas of the workpiece. This can be used to create contours, ring ducts, grooves or bell hollows with no contact but very high precision. The removed material may be precipitated from the electrolyte solution in the form of metal hydroxide. However, electrochemical machining requires specific tooling, which defeats the benefit of AM since there may be an infinitely and arbitrary large set of different geometries that may be addressed in AM.

Another mass finishing technique is abrasive flow machining, which flows an abrasive-laden fluid (or a semi-solid abrasive-laden putty) through or across parts to grind (e.g., finish) or remove a small quantity of material from a surface to be finished at very high temperatures. Abrasive flow machining may be useful when applied to workpieces containing passageways that are considered to be inaccessible with conventional deburring and polishing tools. However, equipment for abrasive flow machining is very expensive and features must be designed to adapt to the equipment. In addition, in abrasive flow machining techniques, each passageway has to be addressed independently, which may not be practical for node-based structures with complex geometries.

Although these mass finishing techniques may be applied to objects with simple internal surfaces (e.g., one passage in a consistent size), these mass finishing techniques may not be viable for parts with multiple passages containing different sizes, different orientations and different trajectories.

Accordingly, it would be useful to implement a general solution to the above mentioned issues by effectively molding a tool in situ to the part of the node to be treated. In addition, having a robust solution to clean up complex geometries of AM objects would allow mass printing of these types of traditionally, very difficult to finish geometries at a higher rate that is more economical. Furthermore, the solution may also be used to clean up internal surfaces with multiple and complex passages.

The present disclosure is directed to finishing surfaces of complex AM objects in robotic assembly cells. Specifically, the present disclosure describes a process of finishing complex internal passageways of topologically optimized AM objects using electropolishing and/or chemical based polishing combined with two different materials. The first material is used to evenly coat a surface of the material to create a gap. During an electropolishing or chemical based polishing process, the second material is used coat the first material and create a tool that is configured as an anode or cathode for the removal process. The first material is then removed to maintain the gap between the electrodes. This process may be repeated multiple times until a desired finish is produced for all part surfaces.

### Additive Manufacturing Environment

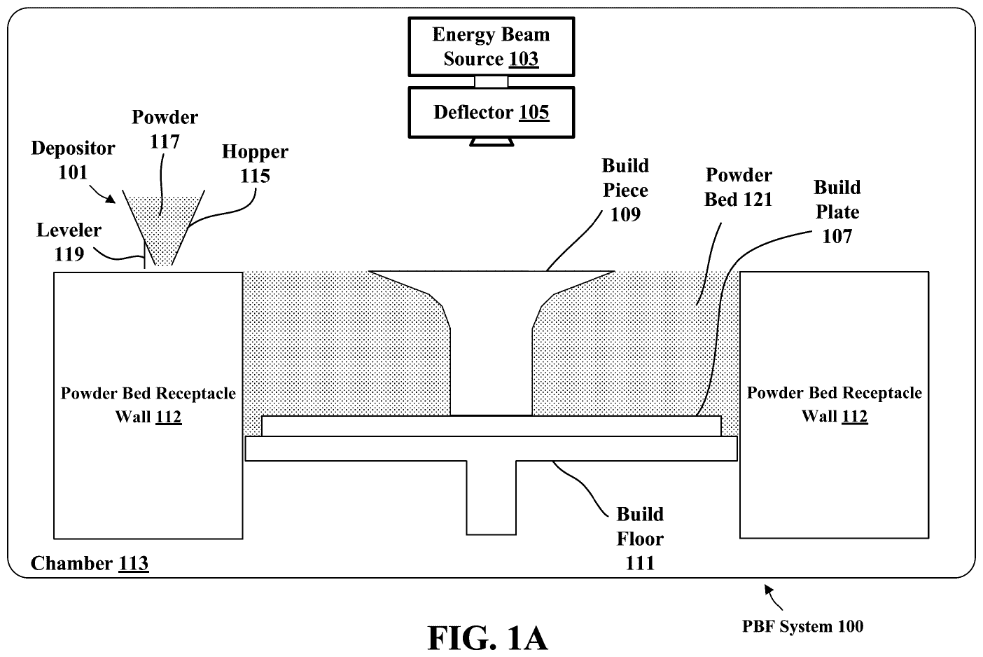

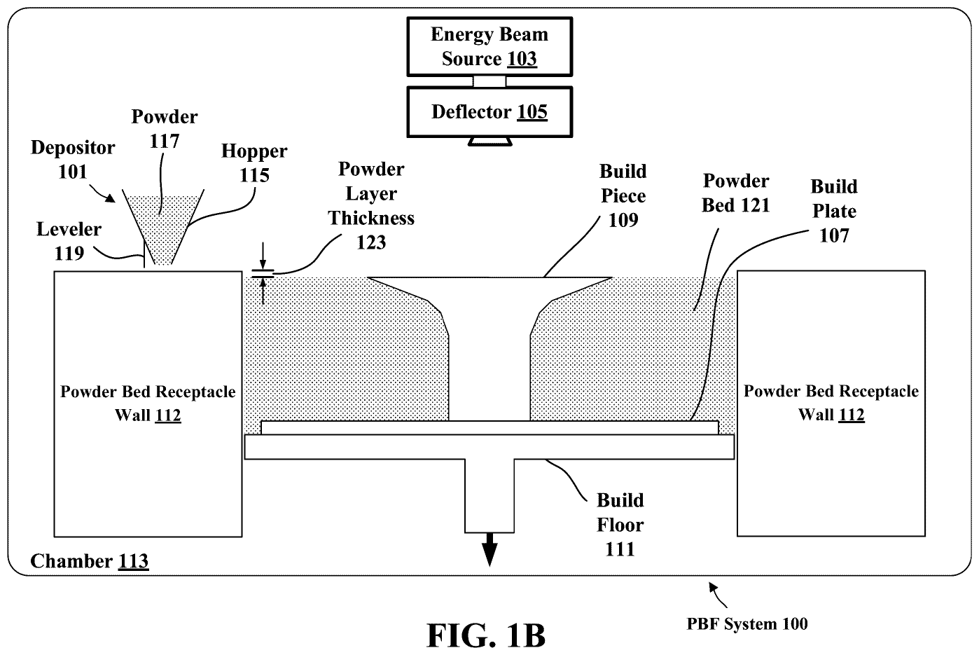

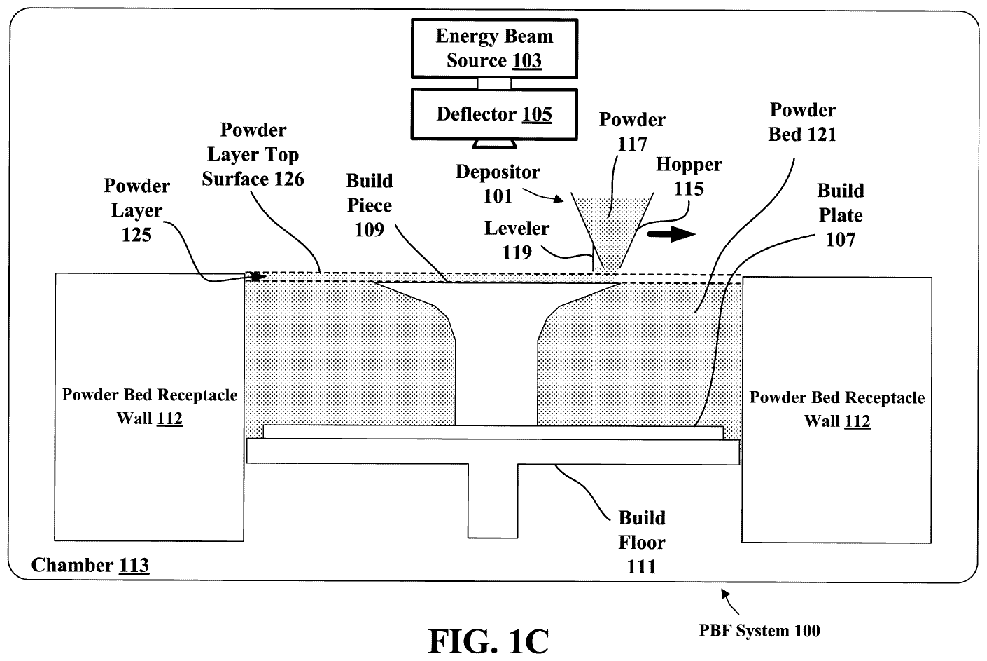

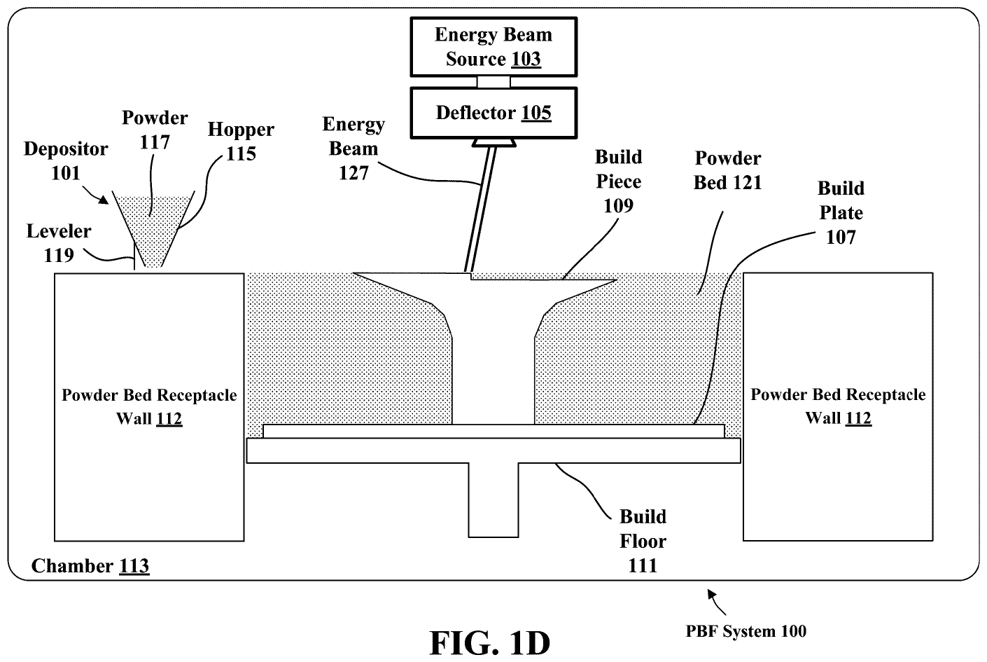

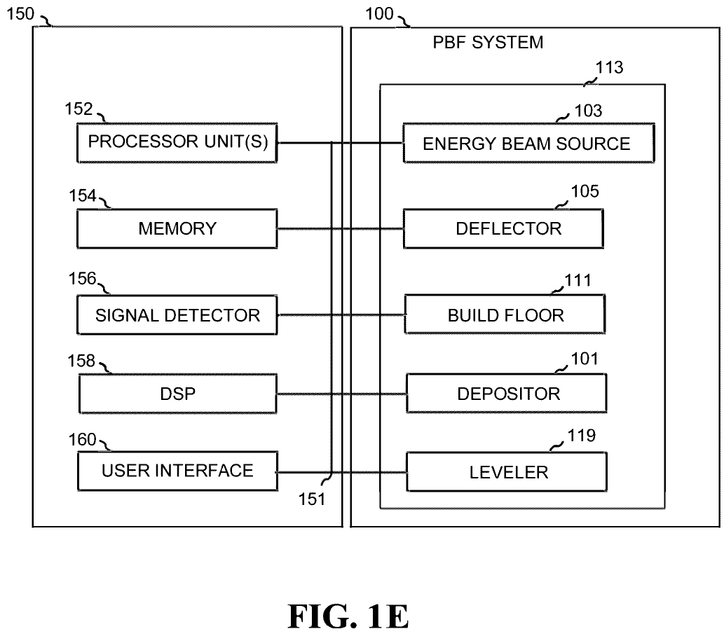

FIGS. 1A-1D illustrate respective side views of a 3-D printer system in an aspect of the present disclosure.

In an aspect of the present disclosure, a 3-D printer system may be a powder-bed fusion (PBF) system 100. FIGS. 1A-D show PBF system 100 during different stages of operation. The particular embodiment illustrated in FIGS. 1A-1D is one of many suitable examples of a PBF system employing principles of this disclosure. It should also be noted that elements of FIGS. 1A-1D and the other figures in this disclosure are not necessarily drawn to scale, but may be drawn larger or smaller for the purpose of better illustration of concepts described herein. PBF system 100 can include a depositor 101 that can deposit each layer of metal powder, an energy beam source 103 that can generate an energy beam, a deflector 105 that can apply the energy beam to fuse the powder material, and a build plate 107 that can support one or more build pieces, such as a build piece 109. Although the terms “fuse” and/or “fusing” are used to describe the mechanical coupling of the powder particles, other mechanical actions, e.g., sintering, melting, and/or other electrical, mechanical, electromechanical, electrochemical, and/or chemical coupling methods are envisioned as being within the scope of the present disclosure.

PBF system 100 can also include a build floor 111 positioned within a powder bed receptacle. The walls of the powder bed receptacle 112 generally define the boundaries of the powder bed receptacle, which is sandwiched between the walls 112 from the side and abuts a portion of the build floor 111 below. Build floor 111 can progressively lower build plate 107 so that depositor 101 can deposit a next layer. The entire mechanism may reside in a chamber 113 that can enclose the other components, thereby protecting the equipment, enabling atmospheric and temperature regulation and mitigating contamination risks. Depositor 101 can include a hopper 115 that contains a powder 117, such as a metal powder, and a leveler 119 that can level the top of each layer of deposited powder.

Referring specifically to FIG. 1A, this figure shows PBF system 100 after a slice of build piece 109 has been fused, but before the next layer of powder has been deposited. In fact, FIG. 1A illustrates a time at which PBF system 100 has already deposited and fused slices in multiple layers, e.g., 200 individual layers, to form the current state of build piece 109, e.g., formed of 200 individual slices. The multiple individual layers already deposited have created a powder bed 121, which includes powder that was deposited but not fused.

FIG. 1B shows PBF system 100 at a stage in which build floor 111 can lower by a powder layer thickness 123. The lowering of build floor 111 causes build piece 109 and powder bed 121 to drop by powder layer thickness 123, so that the top of build piece 109 and powder bed 121 are lower than the top of powder bed receptacle wall 112 by an amount equal to the powder layer thickness 123. In this way, for example, a space with a consistent thickness equal to powder layer thickness 123 can be created over the tops of build piece 109 and powder bed 121.

FIG. 1C shows PBF system 100 at a stage in which depositor 101 is positioned to deposit powder 117 in a space created over the top surfaces of build piece 109 and powder bed 121 and bounded by powder bed receptacle walls 112. In this example, depositor 101 progressively moves over the defined space while releasing powder 117 from hopper 115. Leveler 119 can level the released powder to form a powder layer 125 that leaves powder layer top surface 126 configured to receive fusing energy from energy beam source 103. Powder layer 125 has a thickness substantially equal to the powder layer thickness 123 (see FIG. 1B). Thus, the powder in a PBF system can be supported by a powder material support structure, which can include, for example, a build plate 107, a build floor 111, a build piece 109, walls 112, and the like. It should be noted that the illustrated thickness of powder layer 125 (i.e., powder layer thickness 123 (FIG. 1B)) is greater than an actual thickness used for the example involving the 200 previously-deposited individual layers discussed above with reference to FIG. 1A.

FIG. 1D shows PBF system 100 at a stage in which, following the deposition of powder layer 125 (FIG. 1C), energy beam source 103 generates an energy beam 127 and deflector 105 applies the energy beam to fuse the next slice in build piece 109. In various exemplary embodiments, energy beam source 103 can be an electron beam source, in which case energy beam 127 constitutes an electron beam. Deflector 105 can include deflection plates that can generate an electric field or a magnetic field that selectively deflects the electron beam to cause the electron beam to scan across areas designated to be fused. In various embodiments, energy beam source 103 can be a laser, in which case energy beam 127 is a laser beam. Deflector 105 can include an optical system that uses reflection and/or refraction to manipulate the laser beam to scan selected areas to be fused.

In various embodiments, the deflector 105 can include one or more gimbals and actuators that can rotate and/or translate the energy beam source to position the energy beam. In various embodiments, energy beam source 103 and/or deflector 105 can modulate the energy beam, e.g., turn the energy beam on and off as the deflector scans so that the energy beam is applied only in the appropriate areas of the powder layer. For example, in various embodiments, the energy beam can be modulated by a digital signal processor (DSP).

FIG. 1E illustrates a functional block diagram of a 3-D printer system in accordance with an aspect of the present disclosure.

In an aspect of the present disclosure, control devices and/or elements, including computer software, may be coupled to PBF system 100 to control one or more components within PBF system 100. Such a device may be a computer 150, which may include one or more components that may assist in the control of PBF system 100. Computer 150 may communicate with a PBF system 100, and/or other AM systems, via one or more interfaces 151. The computer 150 and/or interface 151 are examples of devices that may be configured to implement the various methods described herein, that may assist in controlling PBF system 100 and/or other AM systems.

In an aspect of the present disclosure, computer 150 may comprise at least one processor unit 152, memory 154, signal detector 156, a digital signal processor (DSP) 158, and one or more user interfaces 160. Computer 150 may include additional components without departing from the scope of the present disclosure.

The computer 150 may include at least one processor unit 152, which may assist in the control and/or operation of PBF system 100. The processor unit 152 may also be referred to as a central processing unit (CPU). Memory 154, which may include both read-only memory (ROM) and random access memory (RAM), may provide instructions and/or data to the processor. A portion of the memory 154 may also include non-volatile random access memory (NVRAM). The processor 152 typically performs logical and arithmetic operations based on program instructions stored within the memory 154. The instructions in the memory 154 may be executable (by the processor unit 152, for example) to implement the methods described herein.

The processor unit 152 may comprise or be a component of a processing system implemented with one or more processors. The one or more processors may be implemented with any combination of general-purpose microprocessors, microcontrollers, digital signal processors (DSPs), floating point gate arrays (FPGAs), programmable logic devices (PLDs), controllers, state machines, gated logic, discrete hardware components, dedicated hardware finite state machines, or any other suitable entities that can perform calculations or other manipulations of information.

The processor unit 152 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, RS-274 instructions (G-code), numerical control (NC) programming language, and/or any other suitable format of code). The instructions, when executed by the one or more processors, cause the processing system to perform the various functions described herein.

The computer 150 may also include a signal detector 156 that may be used to detect and quantify any level of signals received by the computer 150 for use by the processing unit 152 and/or other components of the computer 150. The signal detector 156 may detect such signals as energy beam source 103 power, deflector 105 position, build floor 111 height, amount of powder 117 remaining in depositor 101, leveler 119 position, and other signals. Signal detector 156, in addition to or instead of processor unit 152 may also control other components as described with respect to the present disclosure. The computer 150 may also include a DSP 158 for use in processing signals received by the computer 150. The DSP 158 may be configured to generate instructions and/or packets of instructions for transmission to PBF system 100.

The computer 150 may further comprise a user interface 160 in some aspects. The user interface 160 may comprise a keypad, a pointing device, and/or a display. The user interface 160 may include any element or component that conveys information to a user of the computer 150 and/or receives input from the user.

The various components of the computer 150 may be coupled together by a bus system 151. The bus system 151 may include a data bus, for example, as well as a power bus, a control signal bus, and a status signal bus in addition to the data bus. Components of the computer 150 may be coupled together or accept or provide inputs to each other using some other mechanism.

Although a number of separate components are illustrated in FIG. 1E, one or more of the components may be combined or commonly implemented. For example, the processor unit 152 may be used to implement not only the functionality described above with respect to the processor unit 152, but also to implement the functionality described above with respect to the signal detector 156, the DSP 158, and/or the user interface 160. Further, each of the components illustrated in FIG. 1E may be implemented using a plurality of separate elements.

By way of example, an element, or any portion of an element, or any combination of elements may be implemented using one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors may execute software as that term is described above.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, compact disc (CD) ROM (CD-ROM) or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium comprises a non-transitory computer readable medium (e.g., tangible media).

### Finishing Process

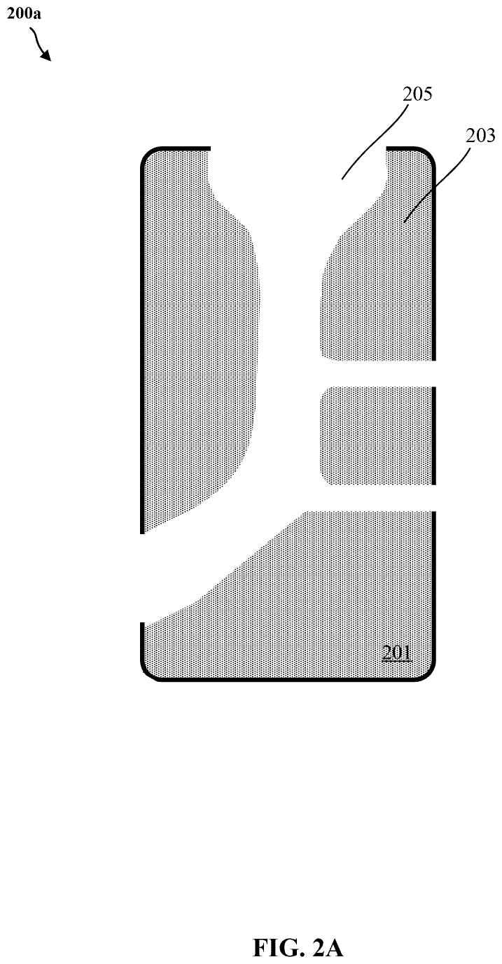

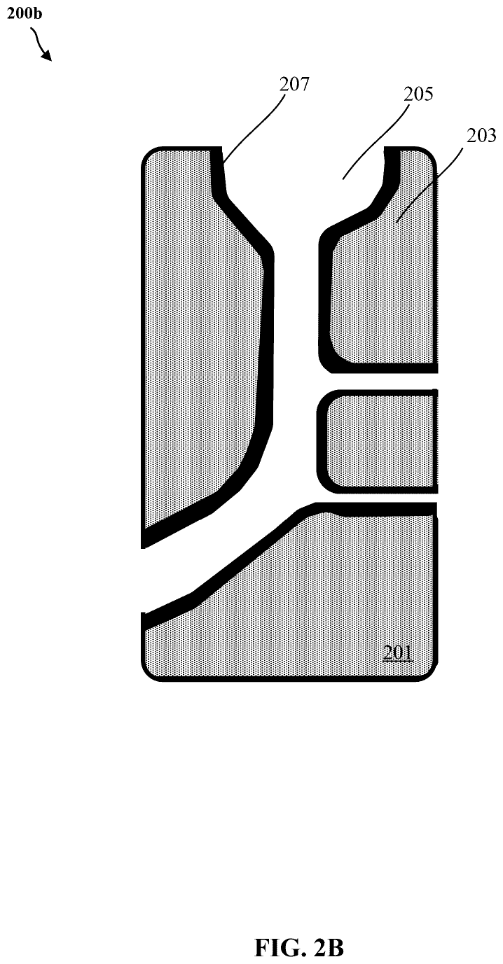

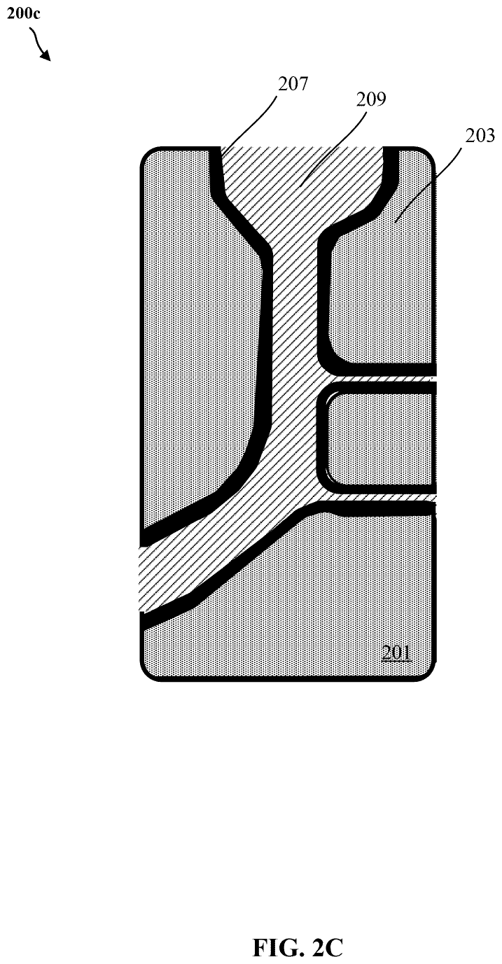

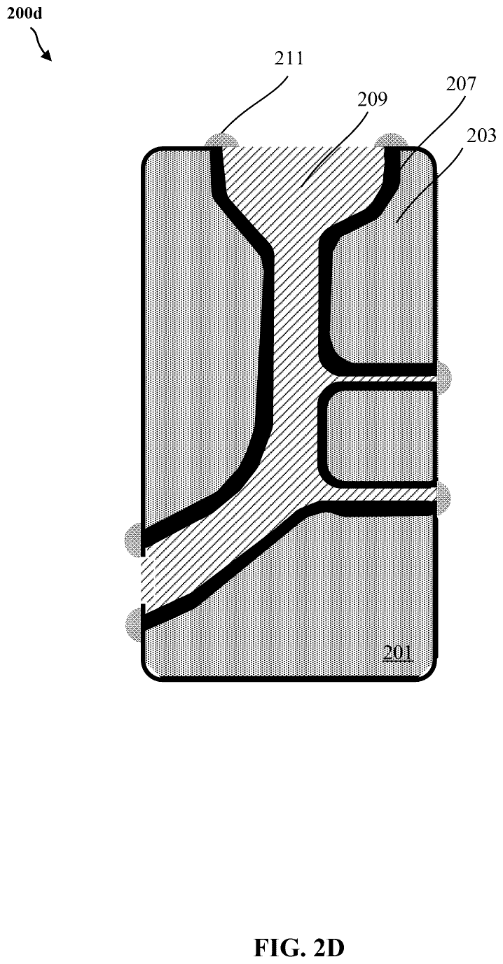

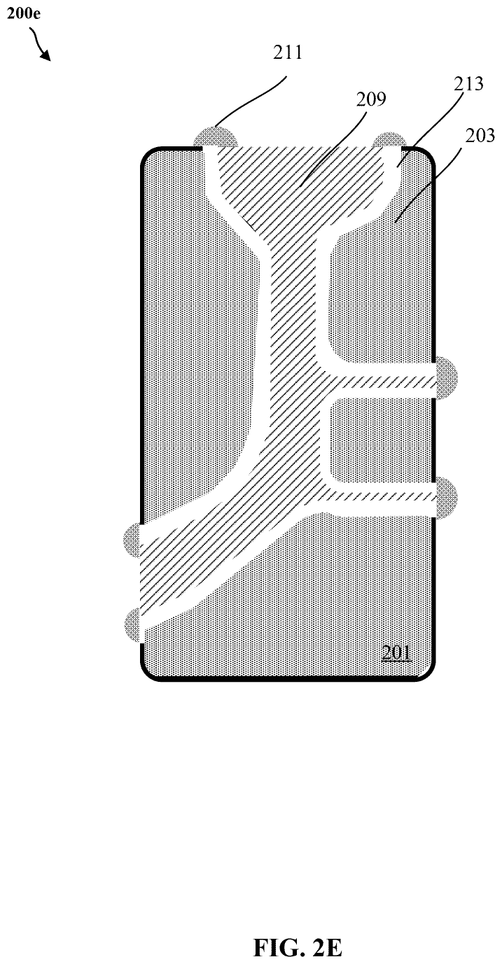

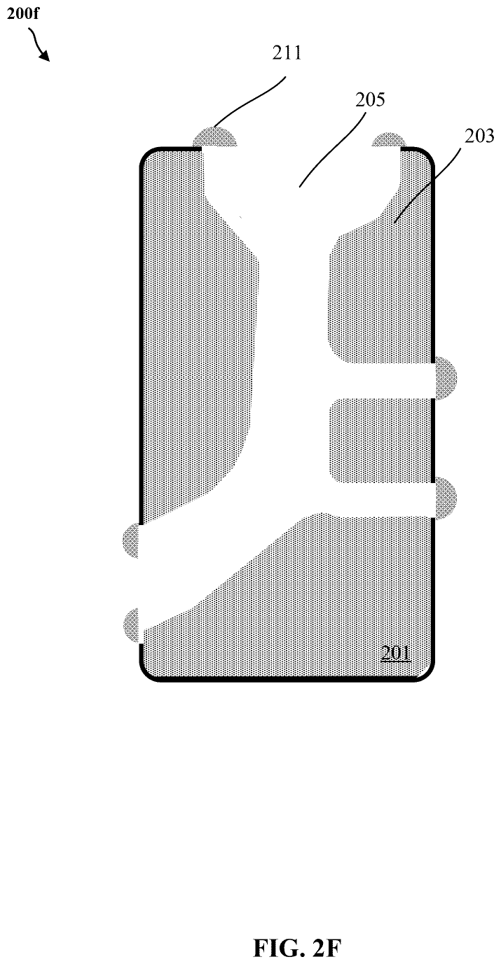

FIGS. 2A-2E illustrate a process of performing a finishing process for internal passageways of AM objects in accordance with an aspect of the present disclosure. In order to mold a tool in situ to a part of the AM object to be treated, a relatively tight controlled gap must be created and maintained between the AM object and the tool.

As shown in example 200a of FIG. 2A, an AM object 201 may contain at least one passageway 205 with a complex shape. For example, the passageway 205 may have different sizes, orientations, and/or trajectories, which make the internal space or internal passages 203 difficult to clean.

As shown in example 200b of FIG. 2B, a first material 207 is fully coated on all internal passages 203 of the AM object 201. Specifically, the first material 207 should evenly coat the surface of all internal passages 203 of the AM object 201 from a surface tension standpoint such that the AM object 201 has an even coverage of the first material 207 throughout the part geometry of the AM object 201. In some examples, the first material 207 may be a low temperature dissolvable material. For example, the first material 207 is a low temperature material that may be removed with a modest temperature such as a wax or other low-melting polymer that can be re-used.

As shown in example 200c of FIG. 2C, a second material 209 is in-filled into the internal passages 203 of the AM object 201 to create a tool for electropolishing (or chemical based polishing) in situ. The second material 209 is configured to be a tool that will either be an anode or cathode for the electrochemical polishing process. The second material 209 is a conducive dissolvable material that has a higher temperature material than the first material 207.

As shown in example 200d of FIG. 2D, optionally, prior to dissolving the first material 207, a fixturing agent 211 may be applied to the AM object 201 to control the spacing (or gap) between the second material 209 and the AM object 201. In other words, the fixturing agent 211 ensures that the gap is as established by the first material 207 and ensures that there is no movement of the second material 209 and the AM object 201 due to the removal of the first material 207. In some examples, the fixturing agent 211 may be glue. In some examples, the fixturing agent 211 may be a light carrying adhesive or any type of fastening method that may be appropriate.

As shown in example 200e of FIG. 2E, the first material 207 is removed to create a gap 213 that allows for a consistent finish of the internal passages even for widely disparate and complex geometries. In some examples, the first material 207 may be removed by melting, dissolving, etc. The gap 213 is governed by a flow characteristic of the first material 207. In some examples, multiple layers may be applied to achieve the desired spacing of the gap 213.

In some examples, as an alternative to using a fixturing agent 211 to secure the gap 213, a feature may be incorporated in a temporary wax-based tool (e.g., such as a puck-based robotic quick connect feature) that facilitates having two metrologically-corrected robots accurately maintain the position between the parts during the process. For example, instead of having a fixturing agent 211 gluing the parts together, there may be a feature cast into the second material 209 that has a feature that a robot end effector to manipulate so that the two parts (e.g., second material 209 and the AM object 201) are maintained accurately relative to the position of each other. As another example, the gap may be secured mechanically (e.g., screwed together). These alternative embodiments provide a benefit of reducing the complexity of the process by eliminating the fixturing agent 211 as a third material.

In some examples, electropolishing is applied to the AM object 201. During the electropolishing process, the second material 209 can be configured as the cathode and the AM object 201 may be configured as the anode. As the processing media is depleted in the gap between the electrodes, the entire AM object 201 may be removed from the electropolishing bath to drain and then be re-immersed, preceding in a cyclic sequence until complete. In some examples, assistance methods for draining the AM object 201 may include blasting the AM object 201 with clean air, vibrating, spinning, etc.

In some examples, chemical polishing is applied to the AM object 201. Chemical polishing is similar to the electropolishing process except that different chemical agents are applied rather than having an electrical component. In the chemical polishing process, the chemical agents are introduced to the inside of the AM object 201 and the materials may be refreshed by pumping compatible acids through the part. If chemical polishing is used, then the second material does not have to be conductive. Instead, the second material is utilized to control the gap.

As shown in example 200f of FIG. 2F, the second material 209 is removed to open back up the least one passageway 205 with a complex shape.

In some examples, the AM object 201 may need to be cleaned to ensure that the electrode is removed from the external surfaces. For example, as the internal surfaces are treated, the internal surfaces may slightly change shape and also become less rough with each cleanup process. In some examples, the whole AM object 201 may be processed and fully enveloped. The overall process may be fully repeated after an initial clean-up phase if a very good finish is required for al part surfaces.

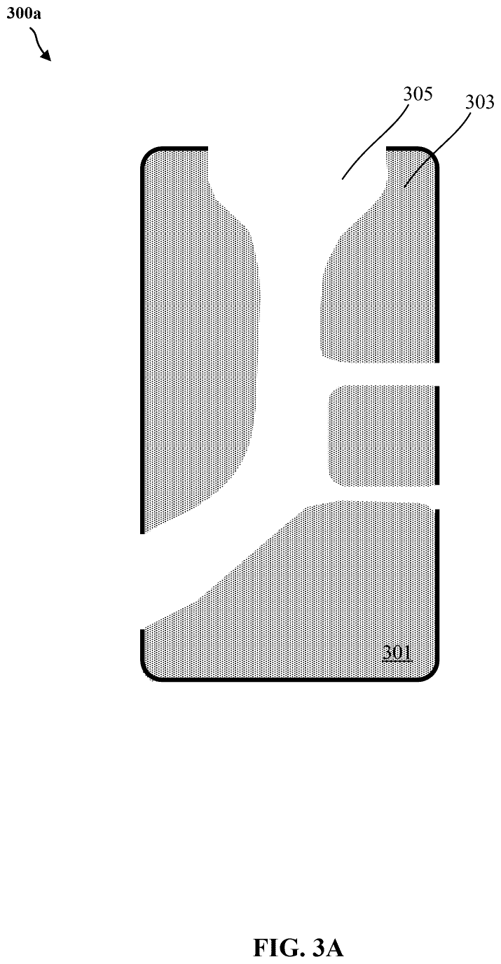

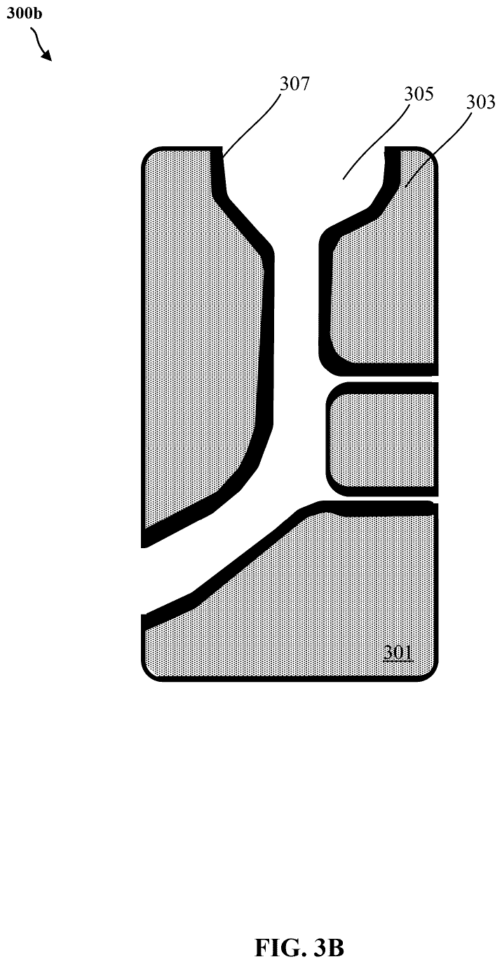

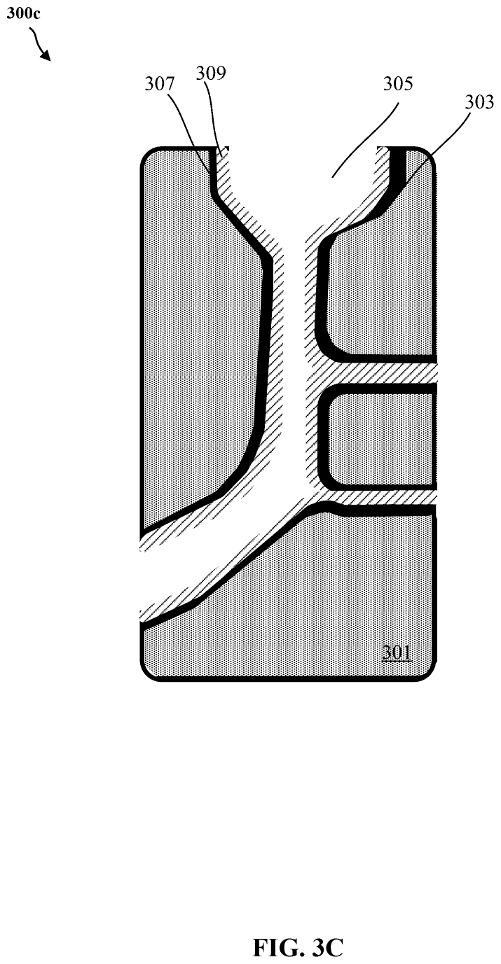

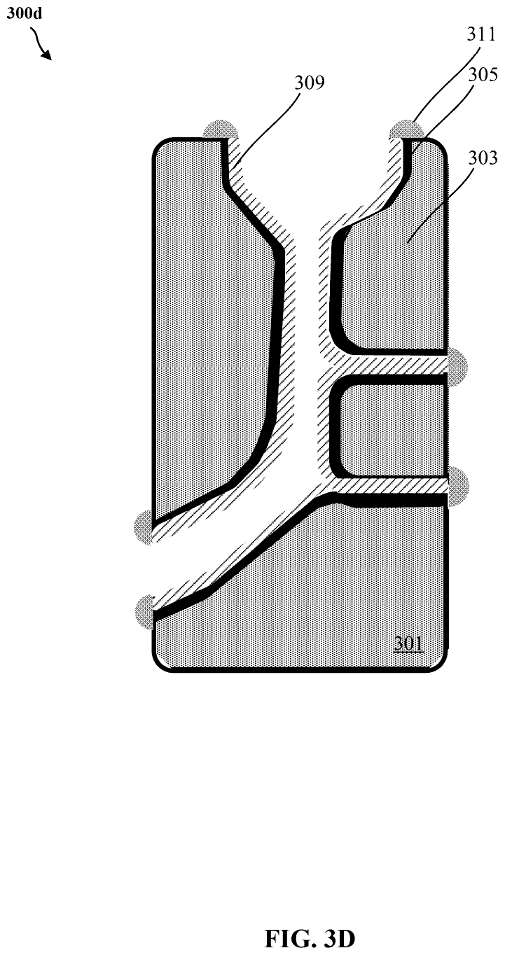

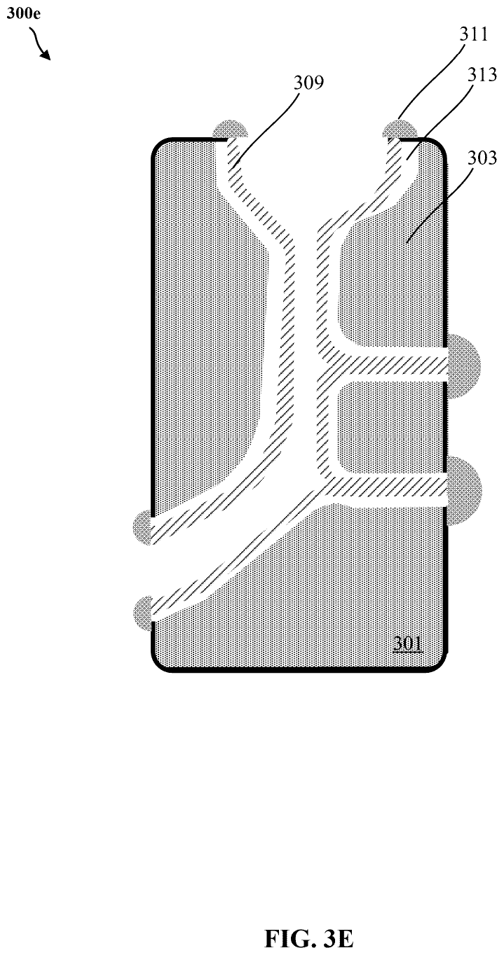

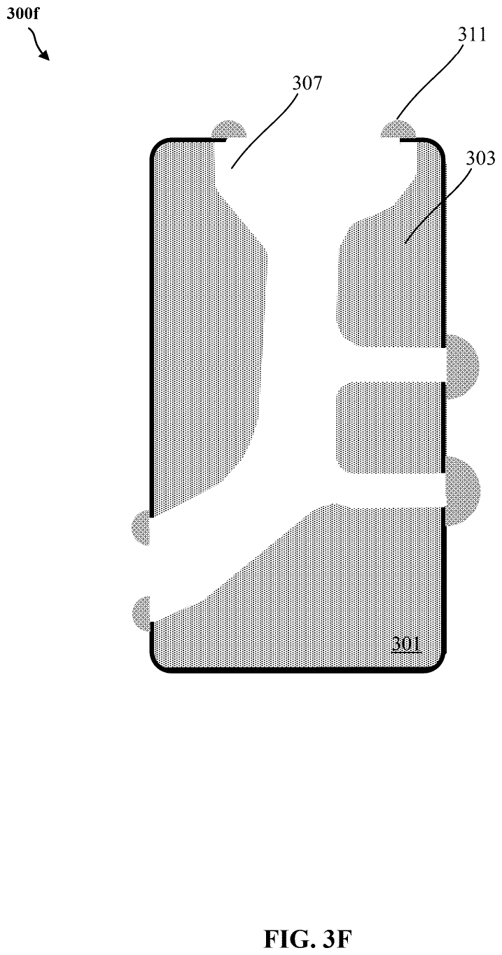

FIGS. 3A-3F illustrate a process of performing a finishing process for internal passageways of AM objects in accordance with an aspect of the present disclosure. FIGS. FIGS. 3A-3F is similar to the process shown in FIGS. 2A-2F except that the second material in FIGS. 3A-3F is not in-filled into an entire cavity of the AM object. Instead, the second material is applied as a coat to the first material.

As shown in example 300a of FIG. 3A, an AM object 301 may contain at least one passageway 305 with a complex shape. For example, the passageway 305 may have different sizes, orientations, and/or trajectories, which make the internal space 303 difficult to clean.

As shown in example 300b of FIG. 3B, a first material 307 is fully coated on all internal passages of the AM object 301. The first material 307 may be a low temperature dissolvable material. Specifically, the first material 307 is a low temperature material that may be removed with a modest temperature such as a wax or other low-melting polymer that can be re-used.

As shown in example 300c of FIG. 3C, a second material 309 is coated onto the first material 307 in the internal passages of the AM object 301 to create a tool for electropolishing (or chemical based polishing) in situ. The second material 309 is a conducive dissolvable material that has a higher temperature material than the first material 307. In other words, the second material 309 may be a shell of a shell as long as the second material 309 is thick enough to handle a current or force involved in the electropolishing process.

As shown in example 300d of FIG. 3D, optionally, prior to dissolving the first material 307, a fixturing agent 311 may be applied to the AM object 301 to control the spacing between the second material 309 and the AM object 301. In some examples, the fixturing agent 311 may be glue.

As shown in example 300e of FIG. 3E, the first material 307 is removed to create a gap 313 that allows for a consistent finish of the internal passages even for widely disparate and complex geometries. In some examples, the first material 307 may be removed by melting, dissolving, etc. The gap 313 is governed by a flow characteristic of the first material 307. In some examples, multiple layers may be applied to achieve the desired spacing of the gap 313.

In some examples, as an alternative to using a fixturing agent 311 to secure the gap 313, a feature may be incorporated in a temporary wax-based tool (e.g., such as a puck-based robotic quick connect feature) that facilitates having two metrologically-corrected robots accurately maintain the position between the parts during the process. This provides a benefit of reducing the complexity of the process by eliminating the fixturing agent 311 as a third material.

During the electropolishing process, the second material 309 can be configured as the cathode and the AM object 301 may be configured as the anode. As the processing media is depleted in the gap between the electrodes, the entire AM object 301 may be removed from the electropolishing bath to drain and then be re-immersed, preceding in a cyclic sequence until complete. In some examples, assistance methods for draining the AM object 301 may include blasting the AM object 301 with clean air, vibrating, spinning, etc.

As shown in example 300f of FIG. 3F, the second material 309 may be removed.

In some examples, the AM object 301 may need to be cleaned to ensure that the electrode is removed from the external surfaces. In some examples, the whole AM object 301 may be processed and fully enveloped. The overall process may be fully repeated after an initial clean-up phase if a very good finish is required for al part surfaces.

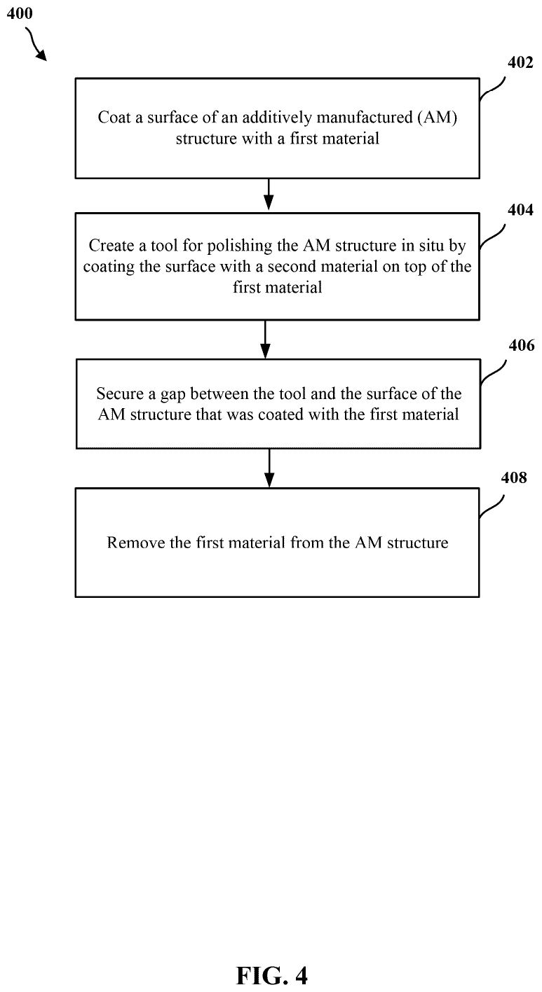

FIG. 4 is a flowchart illustrating an exemplary process of performing a finishing process for internal passageways of AM objects in accordance with the systems and methods described herein. The exemplary process may be implemented, at least in part, using an exemplary 3-D printer system. Some aspects may be implemented using other tools, systems, or devices, as is discussed herein. For example, one 3-D printer system may be the PBF system 100 discussed in FIGS. 1A-1E.

At block 402, the method 400 may include coating a surface of an additively manufactured (AM) structure with a first material.

At block 404, the method 400 may include creating a tool for polishing the AM structure in situ by coating the surface with a second material on top of the first material.

In some examples, creating the tool may further comprise filling a cavity of the AM structure with the second material. As an example, referring back to FIG. 2C, a second material 209 is in-filled into the internal passages 203 of the AM object 201 to create a tool for electropolishing (or chemical based polishing) in situ.

In some examples, creating the tool may further comprise partially filling a cavity of the AM structure with the second material. As an example, referring back to FIG. 3C, a second material 309 is coated onto the first material 307 in the internal passages of the AM object 301 to create a tool for electropolishing (or chemical based polishing) in situ.

In some examples, the first material may be a material configured to be dissolvable at a first temperature and the first material may be removed from the AM structure by dissolving the first material at a first temperature.

In some examples, the first material may correspond to a wax or a low-melting polymer.

In some examples, the first material may be alcohol soluble.

In some examples, the first material may be water soluble.

At block 406, the method 400 may include securing a gap between the tool and the surface of the AM structure that was coated with the first material. The gap may be based on a flow characteristic of the first material.

In some examples, the gap may be secured using a fixturing agent. In some examples, the fixturing agent may be a glue.

Optionally, the method 400 may include performing a curing process to secure the gap. The fixturing agent may be an in-curing adhesive.

In some examples, the gap may be secured mechanically.

In some examples, the gap may be secured using a feature incorporated in a wax-based tool configured to facilitate one or more robots maintaining a position between the AM structure and the tool.

At block 408, the method 400 may include removing the first material from the AM structure.

In some examples, the first material may be removed by melting or dissolving.

In some examples, the surface may be internal and the first material may be configured to fully coat all internal passages of a node.

In some examples, the surface may be external.

Optionally, the method 400 may include: re-coating a surface of the additively manufactured (AM) structure with the first material; re-creating an additional tool for polishing the AM structure in situ by re-coating the surface with the second material on top of the first material; securing at least a gap between the additional tool and a portion of the AM structure that was coated with the first material, wherein the gap is based on a flow characteristic of the first material; and re-removing the first material from the AM structure.

It is understood that the method illustrated by FIG. 4 is exemplary in nature and that the steps described herein may be combined or modified to generate alternative embodiments.

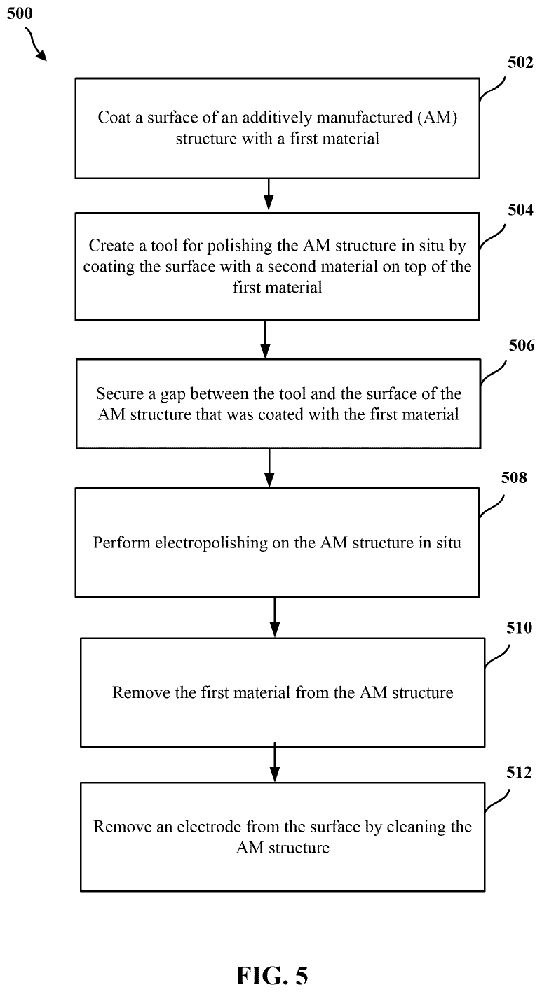

FIG. 5 is a flowchart illustrating an exemplary process of performing a finishing process for internal passageways of AM objects in accordance with the systems and methods described herein. The exemplary process may be implemented, at least in part, using an exemplary 3-D printer system. Some aspects may be implemented using other tools, systems, or devices, as is discussed herein. For example, one 3-D printer system may be the PBF system 100 discussed in FIGS. 1A-1E.

At block 502, the method 500 may include coating a surface of an additively manufactured (AM) structure with a first material.

At block 504, the method 500 may include creating a tool for polishing the AM structure in situ by coating the surface with a second material on top of the first material.

At block 506, the method 500 may include securing a gap between the tool and the surface of the AM structure that was coated with the first material. The gap may be based on a flow characteristic of the first material.

At block 508, the method 500 may include performing electropolishing on the AM structure in situ. The second material may be a conductive material configured to be dissolvable at a second temperature higher than the first temperature.

In some aspects, the second material may be configured as a cathode and the AM structure may be configured as an anode.

At block 510, the method 500 may include removing the first material from the AM structure.

At block 512, the method 500 may include removing an electrode from the surface by cleaning the AM structure.

It is understood that the method illustrated by FIG. 5 is exemplary in nature and that the steps described herein may be combined or modified to generate alternative embodiments.

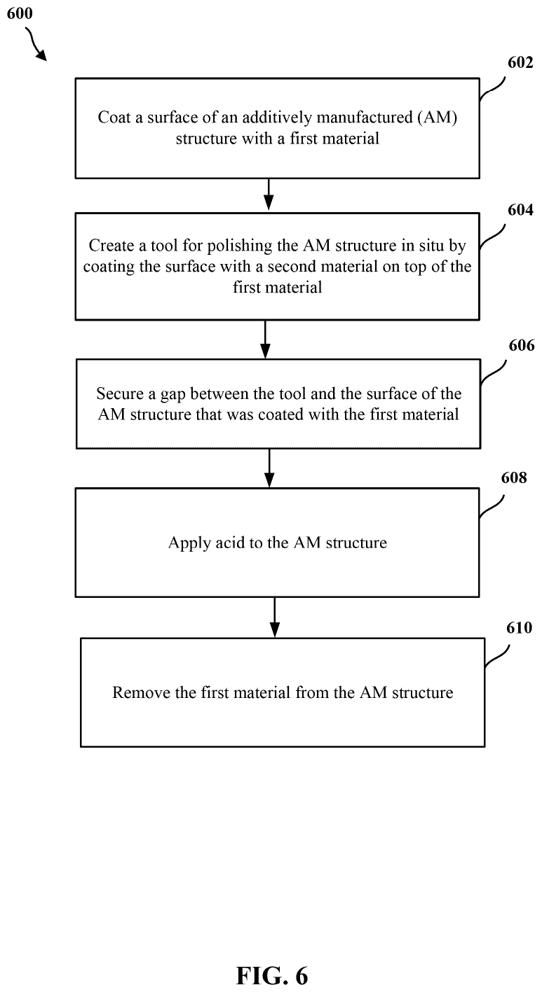

FIG. 6 is a flowchart illustrating an exemplary process of performing a finishing process for internal passageways of AM objects in accordance with the systems and methods described herein. The exemplary process may be implemented, at least in part, using an exemplary 3-D printer system. Some aspects may be implemented using other tools, systems, or devices, as is discussed herein. For example, one 3-D printer system may be the PBF system 100 discussed in FIGS. 1A-1E.

At block 602, the method 600 may include coating a surface of an additively manufactured (AM) structure with a first material.

At block 604, the method 600 may include creating a tool for polishing the AM structure in situ by coating the surface with a second material on top of the first material.

At block 606, the method 600 may include securing a gap between the tool and the surface of the AM structure that was coated with the first material. The gap may be based on a flow characteristic of the first material.

At block 608, the method 600 may include applying acid to the AM structure. The second material may not be a conductive material.

At block 610, the method 600 may include removing the first material from the AM structure.

It is understood that the method illustrated by FIG. 6 is exemplary in nature and that the steps described herein may be combined or modified to generate alternative embodiments.

The previous description is provided to enable any person skilled in the art to practice the various aspects described herein. Various modifications to these exemplary embodiments presented throughout this disclosure will be readily apparent to those skilled in the art, and the concepts disclosed herein may be applied to other techniques for printing structures and interconnects. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A method comprising:
coating a surface of an additively manufactured (AM) structure with a first material;
creating a tool for polishing the AM structure in situ by coating the surface with a second material on top of the first material;
securing a gap between the tool and the surface of the AM structure that was coated with the first material, wherein the gap is based on a flow characteristic of the first material; and
removing the first material from the AM structure.

2. The method of claim 1, wherein the first material is a material configured to be dissolvable at a first temperature and the first material is removed from the AM structure by dissolving the first material at a first temperature.

3. The method of claim 2, wherein the first material corresponds to a wax or a low-melting polymer.

4. The method of claim 1, wherein the first material is alcohol soluble.

5. The method of claim 1, wherein the first material is water soluble.

6. The method of claim 2, further comprising:
performing electropolishing on the AM structure in situ, wherein the second material is a conductive material configured to be dissolvable at a second temperature higher than the first temperature.

7. The method of claim 6, wherein the second material is configured as a cathode and the AM structure is configured as an anode.

8. The method of claim 7, further comprising:
removing an electrode from the surface by cleaning the AM structure.

9. The method of claim 1, further comprising:
applying acid to the AM structure, wherein the second material is not a conductive material.

10. The method of claim 1, wherein the gap is secured using a fixturing agent.

11. The method of claim 10, wherein the fixturing agent is a glue.

12. The method of claim 10, further comprising:
performing a curing process to secure the gap, wherein the fixturing agent is an in-curing adhesive.

13. The method of claim 1, wherein the gap is secured mechanically.

14. The method of claim 1, wherein the gap is secured using a feature incorporated in a wax-based tool configured to facilitate one or more robots maintaining a position between the AM structure and the tool.

15. The method of claim 1, wherein the first material is removed by melting or dissolving.

16. The method of claim 1, wherein the surface is internal and wherein the first material is configured to fully coat all internal passages of a node.

17. The method of claim 1, wherein creating the tool further comprises:
filling a cavity of the AM structure with the second material.

18. The method of claim 1, wherein creating the tool further comprising:
partially filling a cavity of the AM structure with the second material.

19. The method of claim 1, wherein the surface is external.

20. The method of claim 1, further comprising:
re-coating a surface of the additively manufactured (AM) structure with the first material;
re-creating an additional tool for polishing the AM structure in situ by re-coating the surface with the second material on top of the first material;
securing at least a gap between the additional tool and a portion of the AM structure that was coated with the first material, wherein the gap is based on a flow characteristic of the first material; and
re-removing the first material from the AM structure.
